(19) United States
(12) Patent Application Publication
(10) Pub. No.: US 2006/0236347 A1
(43) Pub. Date: Oct. 19, 2006

(54) Digital remote device management system for selectively operating a plurality of remote devices

(76) Inventor: Jayson Holovacs, Dunellen, NJ (US)

Correspondence Address: Ward & Olivo, 708 Third Avenue, New York, NY, 10017, US

(21) Appl. No.: 11/089,518

(22) Filed: Mar. 24, 2005

(51) Int. Cl. H04N 7/18

(52) U.S. Cl. 725/80; 725/81

(57) ABSTRACT

The present invention provides an intelligent, digital, modular remote target device management system for coupling a series of remote target devices to one or more user workstations to allow each user workstation to selectively access and control one or more remote target devices. The target device management system incorporates a centralized switching system that receives keyboard, cursor control device, audio, and input/output module device signals from the user workstation and transmits and applies the signals to the remote target device in the same manner as if the keyboard, cursor control device, audio input source, or input/output module device of the user workstation were directly coupled to the remote target device. Also, the remote target device management system digitally transmits the signals.

### FIELD OF INVENTION

The present invention relates generally to a digital, target access device management system for coupling a plurality of remote target devices (e.g., personal computers, servers, network printers, sound and other peripherals, etc.) to one or more user workstations The system allows users to selectively access and control the plurality of remote devices via the user workstation's keyboard, video monitor, mouse, audio output device, audio input device or input/output (“I/O”) module. I/O modules located at either the user workstation or the remote target device allow auxiliary peripheral devices (i.e., serial devices, parallel devices, Universal Serial Bus (“USB”) devices, switch contacts, auxiliary audio channels, etc.) to be accessed and controlled bi-directionally.

### BACKGROUND OF THE INVENTION

In a typical networked environment, a Local Area Network (“LAN”) or Wide Area Network (“WAN”) allows for individual computers to be connected to several other computers such that the resources of each connected computer are available to each of the connected computers. In this networked environment, a dedicated keyboard, video monitor, mouse, audio output device, audio input device, and/or auxiliary peripheral devices may be employed for each computer.

To maintain proper operation of the LAN or WAN, the system administrator must maintain and monitor each computer. This maintenance frequently requires the system administrator to perform numerous tasks at the user console that is associated with and physically located at the computer. For example, to reboot a computer or to add or delete files, the system administrator is often required to operate the computer using its local, attached keyboard, mouse, video monitor, audio devices, and auxiliary peripheral devices, which may be located at a substantial distance from the system administrator's computer and from other computers connected to the LAN or WAN. Consequently, to accomplish the task of system administration, the system administrator must often physically relocate to the user consoles of remote computers. The same holds for accessing and controlling other remote target devices.

One alternative to physical relocation of the system administrator is the installation of dedicated cables that connect each remote computer to the system administrator's computer in a manner that enables the system administrator to fully access and operate the remote computers. However, such an alternative requires substantial wiring and wire harnessing, both of which may require tremendous costs that increase each time a new computer is added to the system. Additionally, as the distance between the system administrator's computer and the computer equipment increases, a decrease in the quality of the transmitted signal often results. Thus, dedicated cables between the system administrator's computer and remote computer equipment may not provide a feasible alternative.

Generally, space considerations also play an important role in many networked computer environments, especially large-scale operations such as data-centers, server-farms, web-hosting facilities, and call-centers. These environments typically require space to house a keyboard, video monitor, mouse, audio output device, audio input device and/or auxiliary peripheral devices for each computer. Also, wiring is required to connect and power each component to its respective computer. Furthermore, additional space is necessary to house the network interface components (e.g., a hub or other connection device) and wiring (i.e., the wiring that physically connects the computers together either directly or via network interface components). As more equipment is added to a computer network, it becomes more probable that the space required to house the equipment and associated cabling will exceed the space allotted for the computer network. Therefore, network architecture, equipment size, and available space are important issues when designing an effective networked computer environment.

One method of reducing the amount of space required to house a computer network is to eliminate user interface devices (i.e., keyboard, video monitor, mouse, audio output device, audio input device, auxiliary peripheral devices, etc.) that are not essential for proper operation of the computer network. User interface devices and associated wiring may be eliminated if a system administrator is able to access the remote computers from the system administrator's computer, eliminating the need for dedicated user interface equipment and its associated wiring.

Allowing a system administrator to operate remote computers or servers from the system administrator's computer eliminates the need for physical relocation to perform system maintenance or administration. Additionally, this capability decreases the amount of space required to house the computer network. It is also desirable to access other target devices in a similar manner.

Traditionally, analog keyboard, mouse, and video (“KVM”) systems have been used to enable remote operation and control of computers and servers. Recently, digital KVM (“dKVM”) switches and remote management systems have evolved. Analog KVM switches use direct point-to-point wiring among servers, switch hardware, and end-user consoles. Conversely, dKVM technology utilizes conventional network infrastructures generally running TCP/IP or similar protocols to permit remote access and control of computers and other devices.

dKVMs offer several advantages over their analog counterparts. In analog systems, cables connect each server to a switch chassis then connect switches to each other. Additionally, those switches must be connected to each end-user console. The cabling is not only costly, but laborious. dKVM systems offer a simplified solution to this cabling problem. dKVM equipment can be proximate to any computer, with short cables from the dKVM unit to the local computers. Only one Category 5 Universal Twisted Pair (“CAT5”) cable need be run from the dKVM unit to an Ethernet hub. This connection can also be done wirelessly, eliminating the need for the CAT5 cable.

Additionally, dKVM systems make it easier to add more computers to the existing network. When additional computers are added, they do not have to be located in the same room or even same building as in traditional analog based KVM equipment. All that is necessary is to plug in the dKVM unit into an accessible network. This design eliminates the need for more switch-to-switch wire runs, or other cable extenders.

There are generally three types of dKVM solutions: dKVM switches, dKVM appliances, and dKVM hybrids. Initially, dKVM technology was used to gain remote access to a few servers. However, as the technology has expanded, the uses of dKVM solutions have also expanded. Each of the three solutions are usually deployed in highly secure data centers where administrators desire to limit secure hardware access to a few users while assuring general access to additional users as necessary. Further, dKVM solutions offer a lower aggregate cost, making them potentially more desirable to users. dKVM appliances and hybrids are often used in remote satellite offers because of the cost. However, although the dKVM technology offers potentially lower cost, there are still some problems such as video quality and cursor latency that must be overcome in order to ensure users a quality experience similar to analog KVM equipment.

dKVM switches utilize KVM over Internet Protocol (“IP”) (“KVMoIP”) switching. They generally enable control of more than one analog computer input and connect directly to an IP network via a Network Interface Card (“NIC”). Users accessing the dKVM switch can select one or more of the switch inputs at any time and a number of independent user sessions are supported. Traditionally, in analog KVM, only one switch computer can be displayed at any time.

dKVM appliances connect to a single computer or an analog KVM switch. The back-end analog network can be of any size, with the cost per port of a dKVM appliance distributed over all of the analog ports of the KVM network. As with dKVM switches, dKVM appliances generally connect to an IP network via a NIC. Most dKVM appliances known in the art allow users accessing dKVM appliances to select only one port at a time and only a single independent user session is supported by the dKVM appliance.

dKVM hybrid systems consist of a digital circuit embedded in an analog switch. Typically, dKVM hybrids offer a local analog console in addition to a digital port that prepares the analog signals for transmission over TCP/IP networks like the dKVM appliances. One dKVM hybrid known in the art integrates KVMoIP into the base user station of a high user throughput KVM switch system. Generally, one, two, or four digital data paths (“ddp”) are provided.

Further, dKVM software is incorporated into the aforementioned dKVM technologies. dKVM software features several methods of accessing a dKVM device. Local consoles, dial-up, and serial connections offer a backup. Often, proprietary software is implemented within the dKVM device. However, some systems known in the art use web browsers, Virtual Network Computing (“VNC”) clients, etc. to access the dKVM devices.

One system known in the art discloses an extended range communications link for coupling a computer to a keyboard, video monitor, and/or mouse that is located remotely from the computer. The end of the link that is coupled to the computer has a first signal conditioning circuit that conditions the keyboard, video monitor and mouse signals. Conditioning the video monitor signals includes reducing their amplitude in order to minimize the amount of “crosstalk” that is induced on the conductors adjacent to the video signal conductors during transmission of the video signals. This signal conditioning circuit is coupled to an extended range cable having a plurality of conductors that transmit the conditioned signals, power, and logic ground potentials to a second signal conditioning network. This second network restores the video signals to their original amplitude.

Another system discloses a communications link for use between a computer and a display unit, such as a video monitor, that allows these two components to be located up to three hundred (300) feet apart. An encoder located at the computer end of the communications link receives analog red, green and blue signals from the computer and inputs each signal to a discrete current amplifier that modulates the signal current. Impedance matching networks then match the impedance of the red, green and blue signals to the impedance of the cable and transmit the signals to discrete emitter-follower transistors located at the video monitor end of the cable. These transistors amplify the signal prior to inputting it to the video monitor. Concurrently, the horizontal synchronization signal is inputted to a cable conductor and its impedance is not matched to the impedance of the cable, thereby allowing the conductor to attenuate the horizontal synchronization signal and reduce noise radiation.

Yet another system discloses an extended range communications link for transmitting transistor-transistor logic video signals from a local computer to a video monitor located up to a thousand feet from the computer. The link includes a first signal conditioning circuit located at the computer end of the link for reducing the amplitude of the video signals received from the computer and biasing them to a selected potential, where after they are applied to discrete conductors of the link. A second signal conditioning circuit receives and reconstructs the transmitted video signals prior to inputting them to the video monitor. According to the system, performance of this process reduces the appearance of high frequency video noise on the keyboard clock conductor of the transmission cable, preventing keyboard errors.

A different system discloses a video signal multiplexing device for use with a single video monitor that is capable of selecting one video signal from a plurality of computers for display on the video monitor. The multiplexing device has three switch circuits, a control signal generating circuit, three voltage amplifying circuits, three current amplifying circuits, a synchronous signal selection circuit and an interface circuit.

Yet another system known in the art discloses a computerized switching system for coupling a user interface, including a keyboard, mouse, and/or video monitor to one of a plurality of remote computers. A first signal conditioning unit, located at the user interface, includes an on-screen programming circuit that comprises a switch, a processor, and memory and is used to overlay a menu of connected computers on the video monitor of the user interface. After a remote computer is chosen from the overlaid menu, the first signal conditioning unit receives keyboard and mouse signals from the local user interface and generates a data packet for transmission to a central cross point switch. This switch routes the data packet to a second signal conditioning unit located at the selected, remote computer. The second signal conditioning unit then inputs the keyboard and mouse commands into the keyboard and mouse connectors of the remote computer as if the local keyboard and mouse are directly coupled to the remote computer. Video signals produced by the remote computer are also transmitted through the cross point switch to the video monitor of the user interface. The horizontal and vertical synchronization video signals are encoded on one of the red, green, or blue video signals to reduce the quantity of cables required to transmit the video signal from the remote computer to the local interface's video monitor.

Still another system discloses a method for accessing, controlling and monitoring data located on a remote computer from a local host computer. The video raster signal at the remote computer is converted to digital form and compressed after it has undergone a cyclic redundancy check. Software located on the host computer is capable of decoding the compressed video information and displaying it to a user of the local host computer. The remote computer and the local host computer may be connected either via the Public Switched Telephone System (“PSTN”) using modems at either end or via standard cabling. The system is also capable of bi-directionally transmitting mouse and keyboard signals between the host computer and the remote computer.

Still yet another system discloses a video signal distributor that receives, processes, and distributes video signals received from one or more computers to a plurality of video monitors. The video signal distributor includes three transistor-based voltage amplifying circuits to individually amplify the red, green and blue video signals received from each computer prior to transmitting these signals to a video monitor. The video signal distributor also includes a synchronization signal buffering device that receives horizontal and vertical synchronization signals from each computer and generates new synchronization signals based upon the quantity of video signals that are output to the video monitors.

Another system discloses selectively operating a plurality of computers that are connected to one common video monitor. The system includes a single interface device for entering data in any one of the plurality of connected computers. The system also includes a main control circuit which is connected to the interface device, and a selection circuit for providing the entered data and receiving the video signals from the selected computer.

A different system known in the art discloses a system for network switching of computer peripheral data. The system claims essentially unlimited connection of servers to network workstations. It has one or more data converters that convert the keyboard, video and mouse signals into a suitable format for transmission between a network of workstations and servers. A plurality of servers communicates over a corporate network (LAN, WAN, etc.). The KVM ports of the various servers are connected with a cable to converter boxes, which communicate with a maintenance network. The system also provides motherboard access to servers. When a user wishes to access a server, a user workstation communicates via the maintenance network with a corresponding converter for the desired server to gain motherboard access to the server.

Another system known in the art offers a digital keyboard and video system. This system does not provide mouse support (i.e., it is a keyboard and video (“KV”) system as opposed to a KVM system). Additionally, it supports gray-scale VGA video. It also permits secure, remote access via a LAN, WAN, or a dialup connection.

A different system known in the art discloses a dKVM appliance that supports keyboard, video, and mouse. As opposed to the aforementioned system that did not provide mouse support or color video, this system provides support for both mouse and color video. It uses Windows NT-based computers with special Peripheral Component Interconnect (“PCI”) cards and installed off-the-shelf software. The PCI cards and software enable keystrokes and mouse cursor movements to pass through additional PS2 mouse and keyboard ports, where they could then control a single computer or analog switch. The video comes back through a Video Graphics Array (“VGA”) port, where it is digitized and sent to the user. This system has significant lags in screen repainting and mouse tracking, problems commonly known in the art.

Yet another system known in the art discloses a dKVM switch that combines analog technology with digital video technology. This system allows for the simultaneous connection of eight ports for direct connection to servers or other analog switches (i.e., it handles up to eight simultaneous access paths to the eight ports). This simultaneous access means that eight different people could use the dKVM switch to view and control different devices at the same time. It provides upgrades to the system through flash firmware or software upgrades. The system utilizes host and remote software clients and hardware based video sampling. It operates over a high-speed connection and provides no modem support.

A final system known in the art discloses an improvement over existing dKVM equipment wherein the system eliminates the need for the host and remote software client and hardware based video sampling. It offers a dKVM appliance that connects to, on the front end, existing analog KVM systems. The system supports LAN, WAN and dialup connectivity. Additionally, the system supports browser based access, thereby eliminating the requirement for additional software. The system discloses support of up to four digital data paths. Thus, four users can access the system simultaneously.

In view of the foregoing, a need clearly exists for a reliable, efficient, modular, digital, centralized target device management system that minimizes expensive, space-consuming, external hardware, while providing centralized control of multiple remote target devices, including, but not limited to remote computers, servers, network equipment and other peripherals. Such a system should also allow one or more user workstations to access any one of a plurality of remote target devices. Furthermore, such a system should greatly enhance the ability of information technology personnel to manage multiple devices in both the small-scale and large-scale (such as data-centers, server-farms, web-hosting facilities, and call-centers).

### SUMMARY OF THE INVENTION

It is often desirable to allow one or more remote target devices, including, but not limited to, remote computers, remote servers and other remote peripherals, to be accessed and controlled via one or more local sets of peripheral devices including, but not limited to, a keyboard, video monitor, mouse, audio output device, audio input device and auxiliary peripheral devices (i.e., serial devices, parallel devices, USB devices, switch contacts, auxiliary audio channels, etc.). With respect to computing, since the majority of computers in use today are either International Business Machines (“IBM”) computers or clones of an IBM computer, many computers use identical or similar electrical connectors and communication protocols (e.g., PS/2) to connect a peripheral device to a computer. An IBM-compatible computer typically contains one type of electrical connector for each type of peripheral device to which the computer will be connected. Generally, the cables that interface such peripheral devices to the respective electrical connector are approximately six (6) feet in length, limiting the distance from the computer at which the peripheral devices may be located.

In many circumstances, it may be desirable to separate the peripheral devices from the computer due to space constraints. However, one skilled in the art may readily appreciate that separating a computer from its peripheral devices is likely to increase cabling costs. In addition, transmitting signals such as keyboard, video, mouse, audio or auxiliary peripheral device signals over distances greater than fifteen (15) feet is likely to degrade the electrical characteristics of the signal resulting in decreased reliability of keyboard and mouse commands, low quality video and audio, and degraded auxiliary peripheral device signals. This degradation occurs for several reasons, including the induction of “noise”, or “crosstalk”, between adjacent conductors and an increase in the impedance encountered by the transmitted signal.

In addition to extending the distance between a computer and its peripheral devices, it is also convenient to access and operate more than one remote computer from one set of peripheral devices. The same holds for accessing and operating other remote devices. This feature is desirable when space is limited and the use of one set of peripheral devices to control multiple remote devices eliminates the space required to house a dedicated set of peripheral devices for each computer or remote device to be accessed and controlled. Also, the ability to access and control one or more remote computers and other remote devices from one local set of peripheral devices eliminates the need to physically relocate to the remote computer or other device to perform system administration or maintenance for that device. With the advent of new technologies, it is desirable to remotely control not only remote computers, but all types of remote target devices. Also, it is desirable to provide a completely digital solution to accessing and operating remote devices.

The present invention provides a digital, intelligent, modular remote target device management system that enables several simultaneous users to access, control, and operate numerous remote target devices (i.e. remote computers, servers and other devices) from one or more sets of local peripheral devices. This remote target device management system allows a system administrator to access a remote device from one set of peripheral devices, preferably located at the system administrator's desk, without physically traveling to the remote device. Furthermore, if the remote target device does not have a local user, the present invention eliminates the need for a second set of peripheral devices (if present) at the remote device. When accessing remote computers, the present invention also provides compatibility between various operating systems and/or communication protocols. The present invention allows the same set of local peripheral devices to access and control remote computers executing a variety of operating systems and protocols, including but not limited to, those manufactured by Microsoft Corporation (“Microsoft”) (Windows), Apple Computer, Inc. (“Apple”) (Macintosh), Sun Microsystems, Inc. (“Sun”) (Unix), Digital Equipment Corporation (“DEC”), Compaq Computer Corporation (“Compaq”) (Alpha), IBM (RS/6000), Hewlett-Packard Company (“HP”) (HP9000), and SGI (formerly “Silicon Graphics, Inc.”). Additionally, local devices may communicate with remote computers, remote servers, and other remote devices via a variety of protocols including, but not limited to, USB 1.1 and 2.0, IEEE1394, American Standard Code for Information Interchange (“ASCII”), and Recommend Standard-232 (“RS-232”).

A variety of cabling mechanisms may be used to connect the user workstations and the remote devices to the remote target device management system of the present invention. With respect to connecting to remote computers, the preferred embodiment of the present invention incorporates a single CAT5 cable to connect each remote computer and each user workstation to the device management system. However, other cabling or wireless connections may be used without departing from the spirit of the present invention. For other target devices, different cabling or wireless connections may be used, as appropriate, depending on the remote device being connected to the system.

To achieve the desired administration efficiency while reducing costs and promoting space conservation, the present invention provides a system with reduced cabling requirements. Traditionally, operation of remote devices has been limited to computers. It is desirable, however, to use a target access model instead, where the targets can be any remote device.

Therefore, it is an object of the present invention to provide an improved, digital, modular, remote target access device management system that enables a user to control any one of a plurality of remote devices from any one of a plurality of local user workstations through any network or Internet connection.

Further, it is an object of the present invention to allow information technology (“IT”) personnel to easily manage a volume of servers for both small-scale computer centers and large-scale computer centers such as data-centers, server-farms, web-hosting facilities, and call-centers.

In addition, it is an object of the present invention to enable IT personnel to easily control other remote target devices.

It is a further object of the present invention to provide a digital, modular, target access device management system that is easy to install and operate.

Further, it is an object of present invention to provide a remote, digital, modular, target access device management system, which allows error-free communications between peripheral devices of a user workstation and target devices located at an extended distance from the user workstation.

It is also an object of the present invention to provide a modular, digital, remote target access device management system that provides quality, high resolution, digital visual interface (“DVI”) signals after transmission over an extended range.

Furthermore, it is an object of the present invention to allow audio generated internal to or external to a remote target device to be digitally played at a user workstation.

Also, it is an object of the present invention to allow audio generated at a user workstation to be digitally recorded or used for voice control at a remote target device.

In addition, it is an object of the present invention to allow a remote target device's auxiliary peripherals to be accessed and controlled by a local user workstation.

It is also an object of the present invention to allow bi-directional communication of the auxiliary peripheral device signals between the user workstation and one or more remote target devices.

Additionally, it is an object of the present invention to provide a remote network management system, which provides a single consolidated view of all servers and other connected devices from one screen.

Finally, it is an object of the present invention to provide a remote target device management system that is compact and provides readily accessible communications ports.

Other objects, features, and characteristics of the present invention, as well as the methods of operation and functions of the related elements of the structure, and the combination of parts and economies of manufacture, will become more apparent upon consideration of the following detailed description with reference to the accompanying drawings, all of which form a part of this specification.

### BRIEF DESCRIPTION OF THE DRAWINGS

FIG. 1 is a top level schematic representation of the remote target access device management system according to the preferred embodiment of the present invention illustrating the connection of the target user workstations and command center with remote targets through the Master Platform via either cable or wireless connections.

FIG. 2A is a schematic representation of the internal structure of the Target Interface Module (“TIM”) shown in FIG. 1, illustrating connection of the TIM to a target device and a Master Platform.

FIG. 2B is a detailed schematic diagram of the preferred embodiment of the TIM Converter and TIM transceiver located within the TIM of FIG. 2A.

FIG. 3A is a schematic representation of the Master Platform shown in FIG. 1 illustrating a block diagram of the preferred embodiment of the internal structure of the Master Platform.

FIG. 3B is a detailed schematic diagram of the preferred embodiment of the first and second transceivers located within the Master Platform shown in FIG. 3A.

FIG. 4A is a schematic representation of the Target Control user station (“UST-TC”) shown in FIG. 1, including the attached target devices.

FIG. 4B is a detailed schematic diagram of the UST-TC data converter and transceiver shown in FIG. 4A.

### DETAILED DESCRIPTION OF THE DRAWINGS

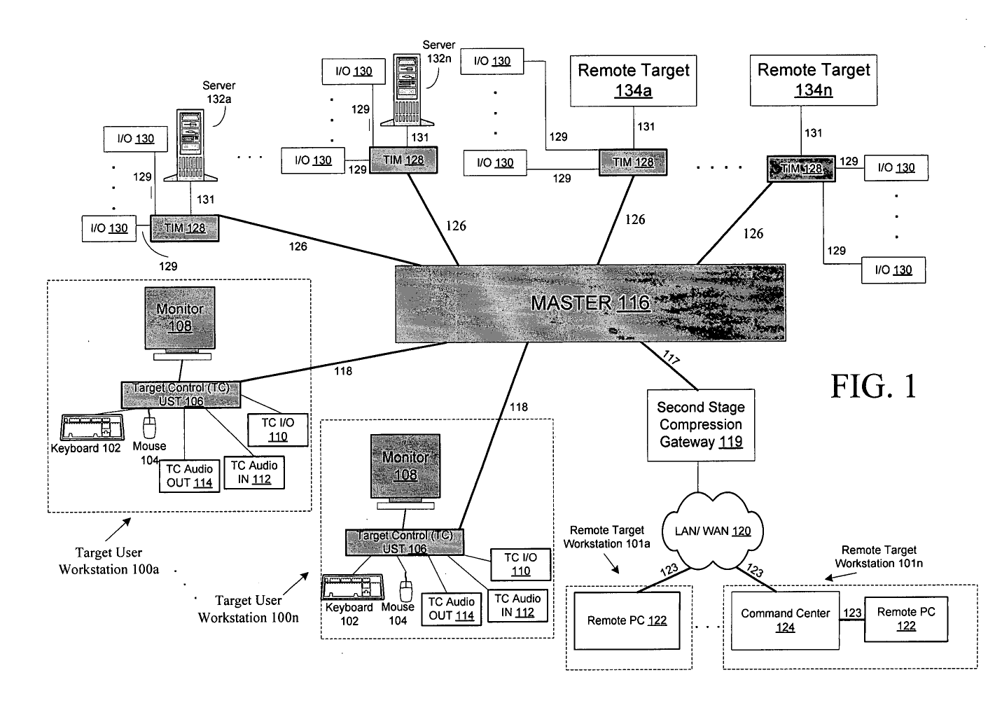

Referring first to FIG. 1, depicted is the architecture of the target access device management system. It includes a centrally located Master Platform 116, target user workstations 100a-n, remote target user workstations 101a-n, TIMs 128, TIM I/O devices 130, remote servers 132a-n, and remote target devices 134a-n. Each target user workstation 100a-n comprises UST-TC 106, keyboard 102, cursor control device 104, video monitor 108, TC I/O module 110, TC audio input device 112, and TC audio output device 114. Additional TC I/O modules 110 are incorporated as necessary. Further, each UST-TC 106 is connected to a Master Platform 116 via connection 118. Connection 118 can be wireless or a variety of different cables allowing for local or remote connection of target user workstations 100a-n to Master Platform 116.

Similarly, connections 126 are either wireless or cables for connecting Master Platform 116 to TIMs 128 allowing for local or remote connection of Master Platform 116 to TIMs 128. I/O module 130 is connected via connection 129 to TIM 128. Connections 131 connect TIMs 128 to remote targets 132a-n, and 134a-n.

TC audio output device 114 may be any device that is capable of receiving audio signals. For example, the devices may be a speaker, an analog recording device, an audio in port of remote target 132a-n, or 134a-n. TC audio input device 112 may be any device that is capable of generating or transmitting audio signals, including, but not limited to, the audio ports of remote targets 132a-n or 134a-n, an analog or digital playback device, an audio-equipped camera and a cellular phone. Analog audio signals from remote targets 132a-n or 134a-n are converted to digital by TIM 128. The digital audio can either remain digital at the TC audio output or be converted back to its original or alternate form.

TC I/O module 110 and TIM I/O module 130 are used to connect auxiliary peripheral devices to UST-TC 106 and TIM 128, respectively. TC I/O module 110 and TIM I/O module 130 may contain one or more ports of varying types for connection to auxiliary peripheral devices. The ports include USB 1.1 and 2.0, IEEE1394, RS-232, RJ-11, RJ-31, RJ-45, RJ-48, BNC, DVI, RGB, S-video, IDE, etc. Various types of peripherals can connect to TC I/O module 110 and TIM I/O module 130. A few examples include, but are not limited to, a keyboard, a cursor control device, an optical cursor control device, a trackball, a Bluetooth device, a cellular telephone, a web camera, a port expander, an analog or digital monitor, a modem, a router, a switch, a wireless network hub, a USB hub, various types of audio devices, and a biometric authentication device.

New types of digital support and other digital features are easily added to the present configuration. TIMs 128 are capable of handling both full-motion and desktop video. In the preferred embodiment, desktop video and full-motion video received from the remote devices may be handled separately. Alternatively, desktop and full-motion video are handled together using off-the-shelf Compressors/Decompressors (“CODECs”) capable of handling both types of video, such as Microsoft's Windows Media Video (“WMV”) 9.0 CODEC. The WMV CODEC allows for the potential to handle both motion and desktop video in one integrated system. TIMs 128 also support multi-channel surround audio, such as Digital Theater System (“DTS”) up to 7.1, Dolby Digital II up to 13.1, Pulse Code Modulation (“PCM”, uncompressed mono or stereo), Audio Coding Revision 3 (“AC-3”), etc. Analog audio is digitized and compressed preferably by TIM 128. The audio signals can be combined into the video stream or sent independently from the video stream.

Each auxiliary peripheral device may either be coupled to UST-TC 106 via TC I/O module 110 or to TIM 128 via TIM I/O module 130. For example, a CD-ROM device may be attached to UST-TC 106 to allow a system administrator to perform software upgrades. The system administrator can then access and upgrade each remote computer or server utilizing the CD-ROM device attached to the system administrator's UST-TC 106. As another example, a tape drive can attach to UST-TC 106 to allow a system administrator to backup multiple computers from the same target user workstation 100a-n utilizing a single tape drive.

In addition, auxiliary peripheral devices may be used for security purposes. For example, a fingerprint reader maybe attached to a target user workstation 100a-n to read the identity of the individual attempting to operate it. The system may be programmed to only allow a system administrator to access and operate target 132a-n, or 134a-n upon fingerprint authentication by the respective remote target. In this manner, user access to the remote targets may be controlled by verifying the identity of the user. Other security measures, such as user passwords and radio frequency identification (“RFID”) technology, may also be used.

The aforementioned examples are for illustrative purposes only and are not intended to define all of the embodiments of the present invention. Other combinations of auxiliary peripheral devices are possible without departing from the spirit of the invention.

TIMs 128, as previously mentioned, can have such ports at USB 1.1 and 2.0, IEEE1394 ports, digital sound input ports, analog sound with internal digitizers, etc. TIM 128 emulates keyboard and mouse with absolute mouse position. They can either be wired or wireless. In the current set up, TIMs 128 connect to Master Platform 116 via 100M or 1000M Ethernet cabling and the wired TIMs are powered over the Internet. A second stage compression gateway 119 performs second stage compression, if necessary, on data streams sent out to LAN/WAN 120. The second stage compression gateway 119 connects via cable or wireless connection 117 to the Master Platform 116. Compression gateway 119 may also be located internally within Master Platform 116. LAN/WAN 120 connects to remote computer 122 and command center 124 via cable or wireless connections 123, encompassed within remote target workstation 101a. Remote target workstation 101n may also include command center 124 (not shown). It is foreseeable that LAN/WAN 120 may also be a Wireless Local Area Network (“WLAN”).

Each target user workstation 100a-n of the target access device management system receives signals from the attached keyboard 102, mouse 104, TC I/O module 110, TC Audio input 112, and TC Audio output 114. The signals received at the UST-TC 106 are packetized. This packetization can be done in a variety of ways. In the present embodiment, a digital method is used.

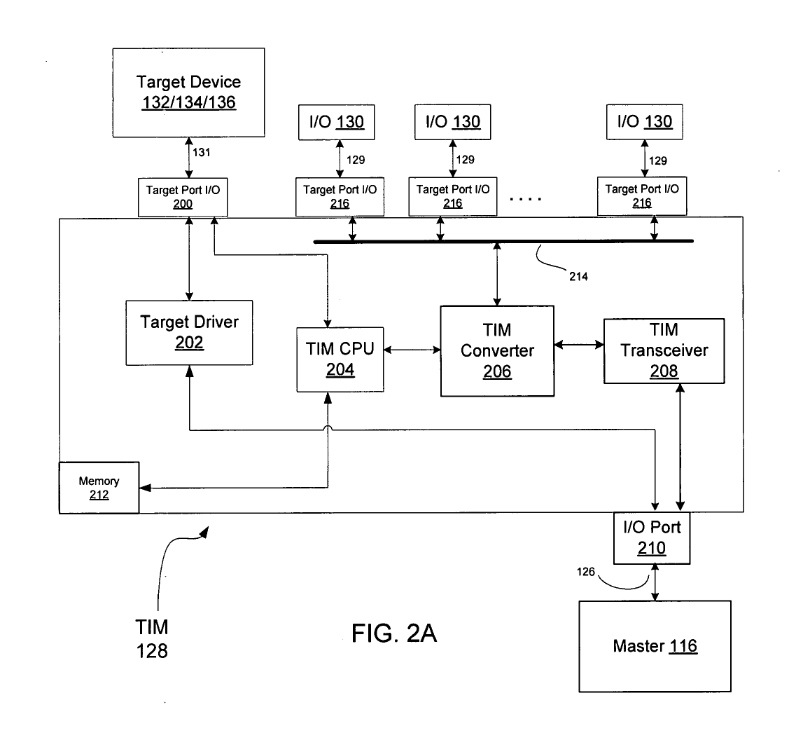

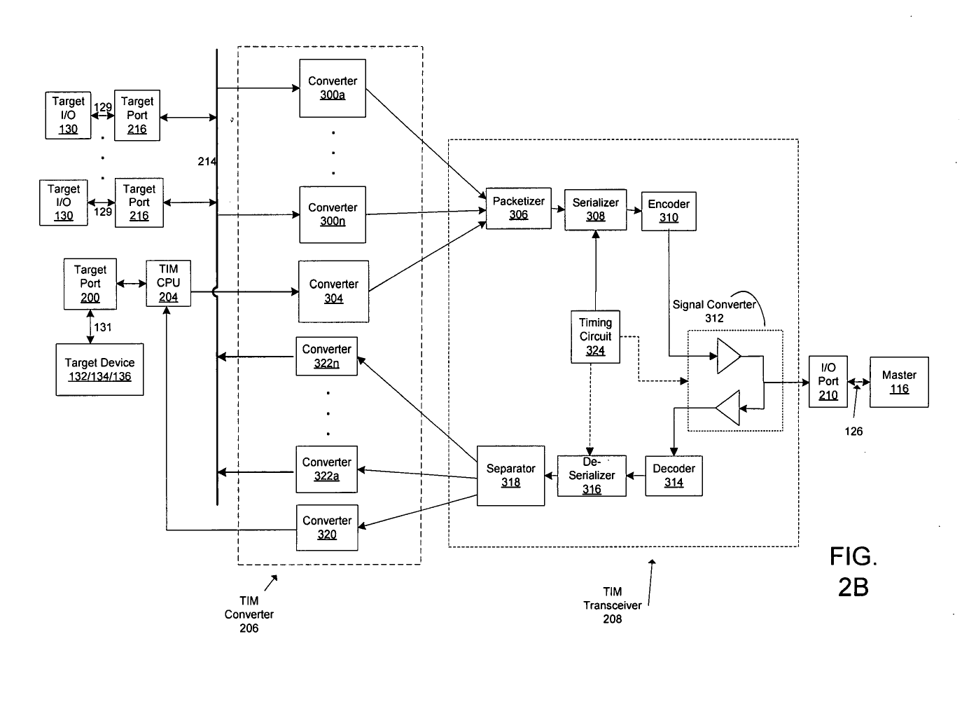

FIG. 2A depicts a schematic diagram of the preferred embodiment of the internal structure of the TIM 128 shown in FIG. 1, illustrating connection of the TIM to a target device and a Master Platform. To one skilled in the art, it is apparent that other embodiments can be used without departing from the spirit of the invention. TIM 128 interfaces with the target device (132a-n, or 134a-n) and I/O modules 130. The devices connected to I/O modules 130 may either be integral to or independent from the target devices. For example, TIM 128 may interface directly to the audio in port and audio out port of the target device or may interface to an independent audio input device, such as a microphone and an independent audio output device, such as a speaker.

The target device (132a-n, or 134a-n in FIG. 1) connects to target I/O port 200 of TIM 128 via connection 131. Target I/O port 216 of TIM 128 connects to I/O module 130 via connection 129. TIM CPU 204 receives the control device signals from the target devices (132a-n, or 134a-n). TIM CPU 204 analyzes and converts the received signals and transmits information to TIM transceiver 208 via TIM converter 206. Simultaneously, TIM converter 206 receives signals from I/O modules 130 via bus 214. The I/O module signals are processed by TIM converter 206 and transmitted to TIM transceiver 208 for transmission to Master Platform 116 via port 210 and cable or wireless connection 126. Target Driver 202 converts the signals from target I/O port 200 and sends them to I/O port 210. Target Driver 202, TIM CPU 204 and TIM transceiver 208 can also receive signals from the I/O port 210 and convert, modify and send them to their respective destinations as necessary. Memory 212 stores the data from TIM CPU 204.

TIM 128 receives signals (either analog or digital) from the target. If the signal is analog, an Analog to Digital (“A/D”) conversion is performed by TIM converter 206. If the signal is already in digital form, no A/D conversion is performed. In this case, the TIM converter may be an interface chip or similar. All of the digital data is preferably multiplexed onto a single data interface that goes to Master Platform 116. If necessary, due to bandwidth limitations, TIM 128 also performs compression or conversion on certain data types, such as different video forms. The TIMs 128 may also provide emulation on necessary interfaces, including, but not limited to, USB 1.1 or USB 2.0.

FIG. 2B shows a schematic diagram of the preferred configuration of TIM converter 206 and TIM transceiver 208. It should be noted that one of skill in the art will realize that this is only one embodiment and that the same functions can be accomplished by only software or only hardware or a combination of hardware and software. As shown, the TIM I/O module signals from target ports 216 are received to converters 300a-n via bus 214. While only two converters are shown, there can be an unlimited number of converters based on the number of I/O module signals received. The converters 300a-n can take a variety of forms depending on the necessary function, including, but not limited to, A/D conversion, audio rate conversion, serial rate conversion and bit conversion. The resulting conversions are digitized, if necessary. Additionally, signals relating to the target device, such as keyboard and cursor control device information, are received from TIM CPU 204 and are input into converter 304, again via bus 214. In the case of keyboard and mouse information, the converter is a serial rate converter which serializes the keyboard and mouse device signals.

TIM transceiver 208 combines the signals from converters 300a-n, and 304 into data packets via packetizer 306. Thereafter, TIM transceiver 208 converts the data packets to a serial format using serializer 308 and encodes the data packet utilizing encoder 310. Signal converter 312 then conditions the data for transmission over the cable or wireless connection 126. Proper network protocol is applied at this step, as necessary. The data packet is then transmitted to I/O port 210 for transmission to Master Platform 116 via cable or wireless connection 126. Timing circuit 324 directs serializer 308 and signal converter 312 to ensure constant data flow.

Target data packets are also received from the Master Platform 116 via cable or wireless connection 126 at port 210. Signal converter 312, located in TIM transceiver 208, converts the data packet from a differential form to its original form and removes network protocol conditioning performed by Master Platform 116. The data packet is then decoded by decoder 314 and de-serialized by de-serializer 316. Timing circuit 324 instructs de-serializer 316 to ensure constant data flow. The packet is then processed by separator 318 which parses the data packet into its original components.

Converters 320, and 322a-n process the received signals. The digitized signals are converted back to analog (DAC conversion) and sent to their respective I/O modules via bus 214, thus completing the cycle.

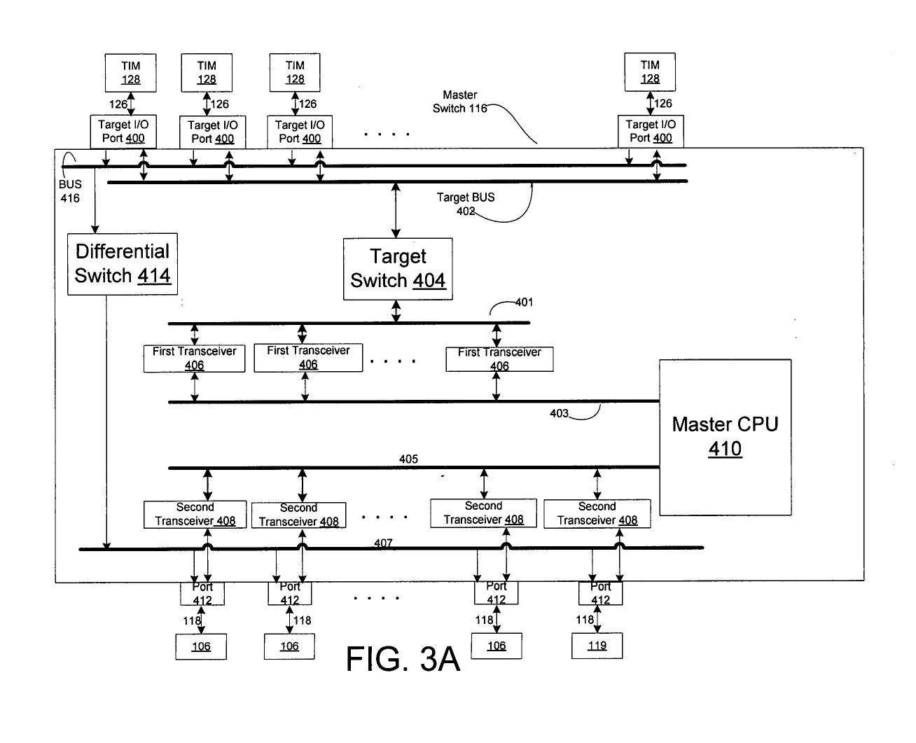

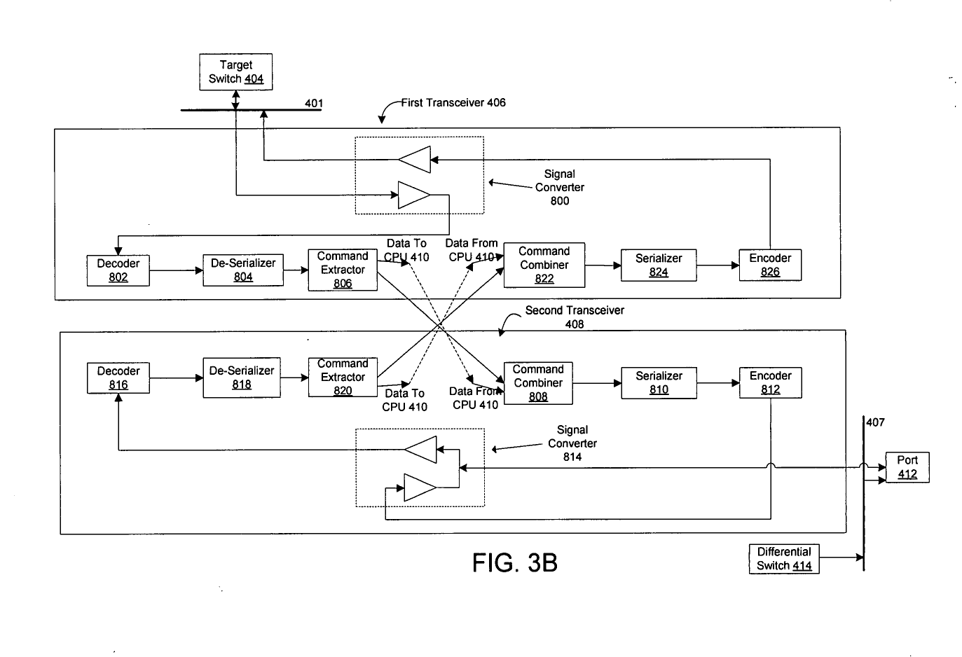

Turning next to FIG. 3A, depicted is a schematic representation of the Master Platform 116, which enables multiple user workstations 100a-n and 101a-n to access multiple remote target devices 132a-n, and 134a-n. This figure illustrates one embodiment. It should be noted, however, that the same functions can be accomplished via any combination of hardware and software without departing from the spirit of the invention. In the preferred embodiment, access to remote targets from target workstation 100a-n is performed solely by one or more Master Platforms 116, independent of any other network that may couple the remote targets to each other such as a LAN, etc. Remote workstation 101a-n connects to the Master Platform(s) via a LAN/WAN 120. In other words, the preferred embodiment with respect to workstation 100a-n does not use an existing computer network to allow a target workstation 100a-n to access and control remote target devices 132a-n, and 134a-n. Rather, all wireless or physical connections between the workstation 100a-n and remote targets 132a-n, and 134a-n occur through one or more Master Platforms. In this way, point-to-point access is achieved. In an alternative embodiment the TIMs may operate over a public network.

In the preferred embodiment, target I/O ports 400 allow a TIM 128 to be connected to its own dedicated port 400 via cable or wireless connection 126. Uni-directional transmitted signals are received at Master Platform 116 via port 400 onto bus 416. The differential switch 414 is capable of routing any signal received from bus 416 to any port 412 via signal path 407. Therefore, differential switch 414 transmits the uni-directional signals to the specific port 412 that is connected to the desired UST-TC 106 or second stage compression gateway 119 via cable or wireless connection 118 or 117, respectively.

In addition to routing the unidirectional digital signals, Master Platform 116 also bi-directionally transmits digital target signals to and from UST-TCs 106 or second stage compression gateway 119 and TIMs 128 via target switch 404. Target Bus 402 allows bi-directional signals between target I/O ports 400 and target switch 404. Target switch 404 sends signals to first transceivers 406 via signal path 401, which in turn send the signals to the Master Platform CPU 410 via signal path 403. This process is detailed in FIG. 3B. The signals are then transmitted to second transceivers 408 and to ports 412, which are connected to UST-TC 106 or second stage compression gateway 119. Signal paths 401, 403, 405 and 407 are merely for simplicity of illustration. They function to illustrate the signals being sent, either uni-directionally or bi-directionally. For example, bi-directional signals are sent between target switch 404 and first transceivers 406. Each first transceiver 406 is connected directly to target switch 404, but is shown as being connected via signal path 401 for to aid in the interpretation of the drawing.

Looking next at FIG. 3B, depicted is a schematic diagram of the first transceiver 406 and second transceiver 408. It should be noted this is only one embodiment and that any combination of hardware and software that can perform the same functions may be substituted without departing from the spirit of the invention. The data packet arrives from the target switch 404 at a signal converter 800 which converts the data packet from a differential form to its original form. The data packet is then transmitted to decoder 802 which decodes the encoded data packet. After the data packet has been processed by decoder 802, the data packet is de-serialized by de-serializer 804 which converts the serial stream of bits in the data packet into a parallel stream of bits. Command extractor 806 then processes the data packet to remove the portion of the packet relating to keyboard, mouse, administrative and other target signals, as necessary. Administrative signals are signals created internal to the target access device management system of the present invention based upon the input of a system administrator or a system programmer. Master Platform CPU 410 utilizes the removed portion of the data packet to determine the proper second transceiver 408 to which to transmit the remainder of the data packet.

The remainder of the data packet is then transmitted from command extractor 806 to command combiner 808 located in second transceiver 408 as determined by Master Platform CPU 410. Command combiner 808 appends a new set of keyboard, mouse, administrative, and other target signals created by Master Platform CPU 410 to the data packet received from command extractor 806. The data packet is then serialized by serializer 810 and encoded by encoder 812. Next, signal converter 814 conditions the data packet for transmission by converting the data packet to a differential signal. Depending on the cabling used, the exact process will vary. Alternatively, under software control, the entire packet can be transmitted from command extractor 806 to command combiner 808 without passing through the Master Platform 116 (shown by dotted arrow).

Data packets containing encoded keyboard, mouse, administrative and other target signals are also transmitted via target switch 404 from port 412 utilizing first transceiver 406 and second transceiver 408. In this scenario, the data packet arrives from port 412 at signal converter 814 located at second transceiver 408 which converts the data packet from a differential form to its original form. The data packet is then transmitted to decoder 816. After the data packet has been decoded by decoder 816, it is de-serialized by de-serializer 818. It is then sent to command extractor 820 where the packet is processed to remove the portion of the data packet relating to keyboard, mouse and administrative signals. Master Platform CPU 410 uses the removed portion of the data packet to determine the proper first transceiver 406 to which to transmit the remainder of the data packet. Alternatively, software control may again be used as previously discussed.

The remainder of the data packet is then transmitted from command extractor 820 to command combiner 822 located in first transceiver 406 as determined by Master Platform CPU 410. Command combiner 822 appends a new set of keyboard, mouse, administrative, and other target signals created by Master Platform CPU 410 to the data packet received from command extractor 820. The data packet is then serialized by serializer 824 and encoded by encoder 826. Signal converter 800 conditions the data packet for transmission and the data packet is transmitted to target switch 404.

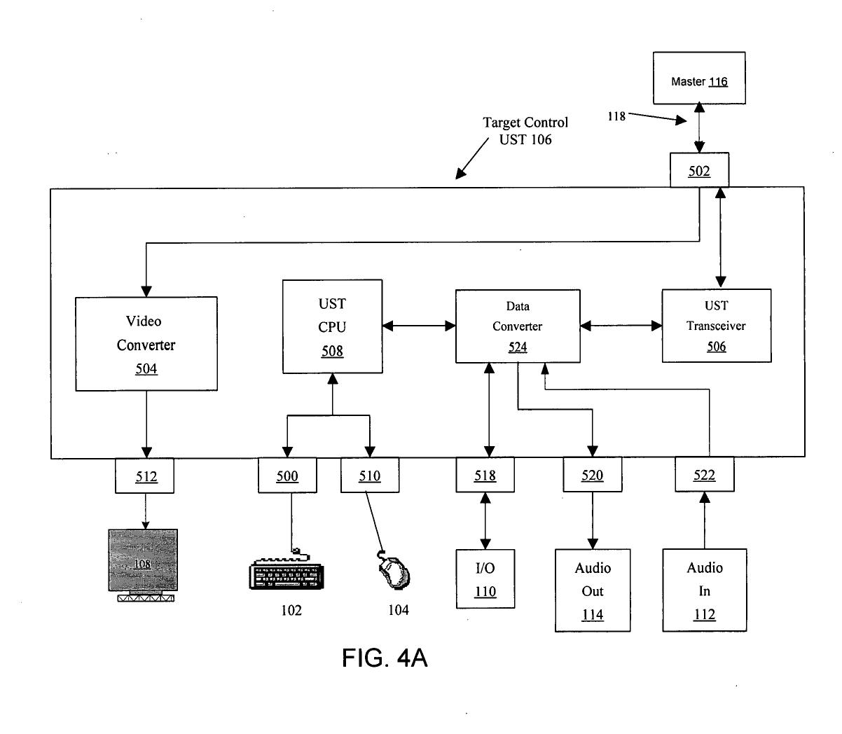

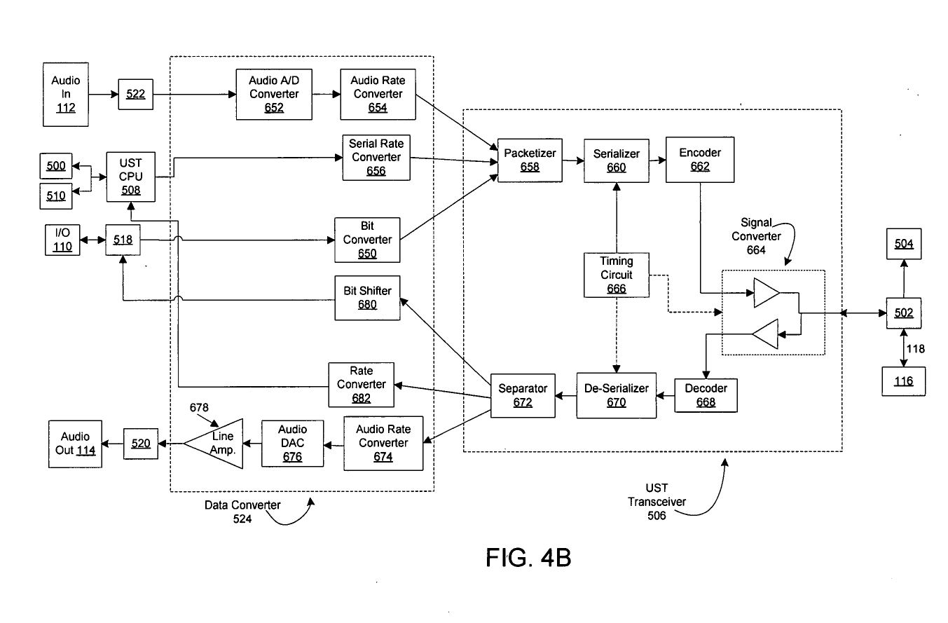

FIG. 4A depicts a schematic diagram of the internal structure of UST-TC 106 shown in FIG. 1. UST-TC 106 interfaces components of target workstation 100a-n (i.e. keyboard 102, mouse 104, video monitor 108, TC I/O module 110, TC Audio input module 112, and TC Audio output module 114) for use with the present invention's system. Keyboard 102, mouse 104, video monitor 108, TC I/O module 110, TC Audio input module 112, and TC Audio output module 114 are connected to keyboard port 500, mouse port 510, video monitor port 512, I/O port 518, audio input port 522 and audio output port 520, respectively, using industry standard keyboard, video, mouse, audio and other device cabling. UST CPU 508 receives signals from keyboard 102 and mouse 104 via keyboard port 500 and mouse port 510, respectively. Thereafter, UST CPU 508 transmits information to UST transceiver 506 via data converter 524 to allow the information to be included in a data packet to be created by UST transceiver 506.

Simultaneously, data converter 524 receives signals from I/O module 110 and audio input module 112 via port 518 and port 522, respectively. Additionally, signals relating to the keyboard and mouse information are received from UST CPU 508 for inclusion in the data packet. UST transceiver 506 combines all the received signals to create data packets. Video converter 504 converts the digital video signals received from Master Platform 116 via cable or wireless connection and port 502 to signals appropriate for viewing on monitor 108 and sends the signals via port 512 to monitor 512.

As shown in FIG. 4B, which depicts a schematic diagram of UST transceiver 506 and data converter 524, the UST I/O module signals received from I/O module 110 via port 518 are input into bit converter 650 located in data converter 524. Bit converter 650 translates UST I/O module signals into a parallel data format. Similarly, the audio signals received from UST audio input device 112 via UST audio input port 522 are converted to digital signals, if necessary, by A/D converter 652. The digitized audio signals are then inputted into audio flow rate converter 654 which formats the rate of data flow. Additionally, signals relating to keyboard and mouse information are received from UST CPU 508 and are inputted into serial rate converter 656 which converts the keyboard and mouse signals to a serial format.

UST transceiver 506 combines signals received from converters 650, 654, and 656 to create data packets in packetizer 658. Thereafter, UST transceiver 506 converts the data packets to a serial format utilizing serializer 660 and encodes the data packet utilizing encoder 662. Signal converter 664 then conditions the packet for transmission via port 502 to either Master Platform 116 over cable or wireless connection 118 or video converter 504. Timing circuit 666 directs serializer 660 and signal converter 664 to ensure constant data flow.

Keyboard, mouse, I/O module, and audio signals in the form of a data packet are received from Master Platform 116 at port 502. Signal converter 664 located in transceiver 506 converts the data packet from a differential form to its original form. Next, the data packet is decoded by decoder 668 and de-serialized by de-serializer 670. Timing circuit 666 instructs de-serializer 670 to ensure constant data flow. Separator 672 processes the data and parses the data packet into its original components.

The received audio signals are processed by audio rate converter 674, which the sends the signal to Audio DAC 676, which converts the digital audio signal to analog. The signal undergoes amplification by line amplifier 678. The amplified analog audio signals are then applied to audio output port 520. However, the signal can remain in digital form if necessary. In this situation, the signal passes through Audio DAC 676 without converting the signal to analog form.

The received I/O module signals are conditioned by bit shifter 680 which converts the I/O module signals from a parallel format to their original format. The I/O module signals are then transmitted to UST I/O module 110 via UST I/O module port 518. The keyboard and cursor control device signals are processed by rate converter 682 and passed through data converter 524 to UST CPU 508, which uses the information contained in the signals to emulate keyboard and cursor control device signals. These emulated signals are applied to keyboard 102 and cursor control device 104 via keyboard port 500 and cursor control device port 510, respectively.

While the present invention has been described with reference to the preferred embodiment and alternative embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

What is claimed is:

1. A remote device management system comprising:
at least one user workstation of the type including at least one from the group consisting of a keyboard, a video monitor, a cursor control device, an audio device, and an input/output module device;
at least one user interface module coupled to said user workstation;
at least one remote device;
at least one remote interface module coupled to said remote device;
a remote device management unit;
a first communications medium providing bi-directional communication for connecting said remote device management unit to said user workstation via said user interface module; and
a second communications medium providing bi-directional communication for connecting said remote device management unit to said remote device via said remote interface module.

2. A system according to claim 1, wherein said remote interface module receives at least one of the group consisting of keyboard signals from said remote device, mouse signals from said remote device, audio signals from said remote device, video signals from said remote device, and input/output modules signals from said remote target device.

3. A system according to claim 2, wherein said video signals from said remote device consist of at least one of the group including desktop, full-motion, and serial terminal interface video.

4. A system according to claim 1, wherein said remote interface module converts analog signals to digital signals.

5. A system according to claim 4, wherein said remote interface module packetizes said digital signals for transmission via said second communications medium to said remote device management unit.

6. A system according to claim 2, wherein said remote interface module digitally transmits at least one of the group consisting of said keyboard signals, said mouse signals, said audio signals, said video signals, and said input/output module signals via said second communications medium to said remote device management unit for transmission to said user workstation.

7. A system according to claim 1, wherein said user interface module receives at least one of the group consisting of user keyboard signals, user mouse signals, user audio signals, and user input/output module device signals from said user keyboard, said user cursor control device, said user audio device, and said input/output module device.

8. A system according to claim 1, wherein said user interface module converts analog signals into digital signals.

9. A system according to claim 8, wherein said user interface device packetizes said digital signals for transmission via said first communications medium to said remote device management unit.

10. A system according to claim 7, wherein said user interface module digitally transmits at least one from the group consisting of said user keyboard signals, said user mouse signals, said user audio signals, and said input/output module device signals via said first communications medium to said remote device management unit for transmission to said remote device via said remote interface module.

11. A method for managing remote devices from a workstation, said method comprising the steps of:
digitizing a first set of signals from said workstation;
packetizing said first set of digital signals for transmission to a remote device from a workstation;
receiving said packetized first set of digital signals at said remote device;
de-packetizing and converting said packetized first set of digital signals for use at said remote device;
digitizing a second set of signals from said remote device;
packetizing said second set of digital signals for transmission from said remote device to said workstation;
receiving said packetized second set of digital signals at said workstation;
de-packetizing and converting said packetized second set of digital signals for use at said workstation; and
remotely controlling said transmission of said first and second sets of digital signals.

12. A method according to claim 11, wherein said first set of signals comprises at least one selected from the group consisting of user keyboard signals of said workstation, user mouse signals of said workstation, user audio signals of said workstation, and user input/output module signals of said workstation.

13. A method according to claim 11, wherein said second set of signals comprises at least one selected from the group consisting of keyboard signals of said remote target device, mouse signals of said remote target device, video signals of said remote target device, audio signals of said remote target device, and input/output module signals of said remote target device.

14. A method according to claim 11, wherein said transmission of said first and second set of digital signals is controlled remotely via a remote device management unit.

15. A method according to claim 14, wherein said remote device management unit is connected to at least one user and one remote interface module via a first and second communications medium, respectively.

16. A method according to claim 15, wherein said user interface module performs said digitization and packetization of said first set of signals.

17. A method according to claim 15, wherein said remote interface module performs said de-packetization and conversion of said first set of digital signals for use at said remote device.

18. A method according to claim 15, wherein said remote interface module performs said digitization and packetization of said second set of signals.

19. A method according to claim 15, wherein said user interface module performs said de-packetization and conversion of said second set of digital signals for use at said workstation.

20. A method according to claim 15, wherein said remote device management unit selectively communicates with said at least one user and one remote interface module.
